(19) United States
(12) Patent Application Publication
(10) Pub. No.: US 2026/0251315 A1
(43) Pub. Date: Aug. 27, 2026

(54) COOKING APPLIANCE (As Amended)

(71) Applicant: LG ELECTRONICS INC., Seoul (KR)

(72) Inventors: Su Il PARK, Seoul (KR); Jeonghoon JEONG, Seoul (KR); Jeahyuk WIE, Seoul (KR); Doo Hyun KIM, Seoul (KR)

(21) Appl. No.: 19/160,116

(22) PCT Filed: Feb. 5, 2024
(86) PCT No.: PCT/KR2024/001664

§ 371 Date: Aug. 27, 2025

(30) Foreign Application Priority Data
Apr. 19, 2023 (KR) 10-2023-0051573

(51) Int. Cl. F24C 15/32; F04D 17/08; F04D 29/28; F04D 29/42

(52) U.S. Cl. CPC F24C 15/322; F04D 17/08; F04D 29/281; F04D 29/4226

(57) ABSTRACT

An invention related to a cooking apparatus is disclosed. The disclosed invention comprises: a first blade unit including a fan comprising a rotating plate and a plurality of blades arranged on the outer side of the rotating plate in a radial direction, wherein each blade extends centrifugally from the rotating plate; a second blade unit protruding from the first blade unit to one side in a first direction; and a third blade unit protruding from the first blade unit to the other side in the first direction.

### TECHNICAL FIELD

The present disclosure relates to a cooking appliance, and more particularly, to a cooking appliance used for cooking food.

### BACKGROUND ART

A cooking appliance is a home appliance for cooking food, and is an apparatus installed in a kitchen space to cook food according to a user's intention. Such cooking appliances may be variously classified according to a heat source, a form, or a type of fuel to be used.

When the cooking appliances are classified according to the type of food being cooked, the cooking appliances may be classified into open type and closed type cooking appliances according to a type of space in which the food is placed. The closed type cooking appliance includes an oven, a microwave oven, etc. and the open type cooking appliance includes a cooktop, a hop, a griddle, etc.

The closed type cooking appliance is a cooking appliance that shields a space in which food is located and heats the shielded space to cook food. In the closed type cooking appliance, a chamber, that is, a cooking chamber, which is a space that is shielded when food is to be cooked while the food is placed, is provided inside the main body. Such a cooking chamber becomes a space in which food is substantially cooked.

In the closed type cooking appliance, a door for selectively opening and closing the cooking chamber is pivotably provided. The door is pivotably installed at a main body having the cooking chamber defined therein via a door hinge disposed between the main body and the door. Such a door may selectively open and close the cooking chamber while pivoting around a portion thereof coupled to the main body via the door hinge.

A heat source is disposed an inner space of the cooking chamber opened and closed by the door to heat the cooking chamber. As the heat source, a gas burner or an electric heater may be used.

In the closed type cooking appliance in which the gas burner is used as the heat source, a plurality of burners may be constructed to heat the cooking target in the cooking chamber. For example, a broil burner is installed in an upper portion of the cooking chamber, and a bake burner is installed in a lower portion or a rear portion of the cooking chamber.

Each of the burners has a flame hole through which mixed gas supplied into the burner is discharged. The mixed gas discharged from the flame hole is ignited by an ignition device to generate a flame. The gas oven may cook the cooking target by heating the cooking target inside the cooking chamber using the generated flame.

A convection device may be further disposed in a rear side of the cooking chamber. The convection device refers to a device that performs an operation of circulating air inside the cooking chamber so that the heat is evenly transferred to the entire cooking chamber. Such a convection device may include a fan cover installed on a rear wall of the cooking chamber, and a convection fan installed in an inner space of the fan cover.

An air intake hole and a discharge hole may be defined in the fan cover. The air intake hole may be formed in a center of a front surface of the fan cover facing the door, and the discharge hole may be formed in a side surface of the fan cover facing a side surface of the cooking chamber.

The convection fan may rotate while being positioned inside the fan cover and generate airflow. Under the operation of the convection fan, air circulation flow may occur such that air in the cooking chamber is suctioned into the fan cover through the air intake hole, and air heated in the fan cover is discharged to the cooking chamber through the discharge hole.

One method for improving the heating efficiency of the cooking appliance is a method of increasing a blowing amount of the convection fan. The easiest way to increase the blowing amount of the convection fan is to increase a diameter of the convection fan.

However, there is a limit in increasing the diameter of the convection fan due to a relationship thereof with other components in the cooking appliance. Accordingly, there is a need for a convection fan design to increase the blowing amount of the convection fan while minimizing a change in the diameter of the convection fan.

### DISCLOSURE

### Technical Purpose

A purpose of the present disclosure is to provide a cooking appliance having a fan having an improved structure to increase a blowing amount.

In addition, another purpose of the present disclosure is to provide a cooking appliance having an improved structure so as to increase a blowing amount of a fan without a design change of a fan cover.

### Technical Solution

A cooking appliance according to an embodiment of the present disclosure in order to achieve the purpose includes a rotatable plate and a fan including a plurality of blades disposed radially outwardly of the rotatable plate, wherein each plate includes a first blade portion extending in a centrifugal direction from the rotatable plate, a second blade portion protruding from the first blade portion toward one side in the first direction, and a third blade portion protruding from the first blade portion toward the other side in the first direction.

In addition, the cooking appliance according to another embodiment of the present disclosure is characterized in that a fan including a rotatable plate provided to be rotatable and a plurality of blades disposed radially outwardly of the rotatable plate is installed in a cooking chamber, and a portion of each of the blades protrudes in a rearward direction of the rotatable plate.

According to an aspect of the present disclosure, there is provided a cooking appliance including: a main body having a cooking chamber defined therein; and a fan installed in the main body, wherein the fan includes: a rotating plate constructed to be rotatable about an axis extending in a first direction; and a blade disposed radially outwardly of the rotating plate, wherein the blade includes a plurality of blades arranged along a rotation direction of the rotatable plate, wherein each of the blades includes: a first blade portion extending in a centrifugal direction from the rotatable plate; a second blade portion protruding from the first blade portion toward one side in the first direction; and a third blade portion protruding from the first blade portion toward the other side in the first direction.

Furthermore, the second blade portions and the third blade portions may be alternately arranged with each other along the rotation direction of the rotatable plate.

Furthermore, the fan may further include a through-hole extending through the blade in the first direction,

Furthermore, the through-hole may be disposed between the second blade portion and the third blade portion in the first direction.

Furthermore, the second blade portion may be formed by cutting a portion of the first blade portion and then bending the cut portion toward one side in the first direction, wherein a cut-away area of the first blade portion may constitute the through-hole.

Furthermore, a coupling groove may be defined in a rear surface of the first blade portion facing the third blade portion and may be concavely recessed toward one side in the first direction.

Furthermore, at least a portion of the third blade portion may be inserted into the coupling groove such that the third blade portion may be coupled to the first blade portion.

Furthermore, a protrusion may protrude from a front surface of the first blade portion toward one side in the first direction.

Furthermore, the coupling groove and the protrusion may be formed together with each other in a pressing process for forming the coupling groove.

Furthermore, the cooking appliance may further comprise a fan cover disposed inside the cooking chamber and having an accommodation space defined therein accommodating therein the fan.

Furthermore, a front surface of the fan cover may be disposed on one side in the first direction of the fan, and a side surface of the fan cover may be disposed radially outwardly of the fan, wherein an air intake hole may be defined in the front surface of the fan cover, wherein an air discharge hole may be defined in the side surface of the fan cover.

In one example, each blade may further include an extension portion protruding from the second blade portion toward one side in the first direction, wherein the extension portion may be disposed between the air intake hole and the second blade portion.

In another example, each blade may further include an extension portion protruding from the second blade portion in a centripetal direction, wherein the extension portion may be disposed between a rotation center of the fan and the second blade portion.

In still another example, each blade may further include an extension portion protruding from the second blade portion toward one side in the first direction and in a centripetal direction, wherein the extension portion may be disposed between the air intake hole and the second blade portion and between a rotation center of the fan and the second blade portion.

### Technical Effect

According to the present disclosure, flow of the air guided by the third blade portion may be added to flow of the air guided by the second blade portion, thereby effectively increasing the blowing amount of the fan.

In addition, according to the present disclosure, only a size in the front-rear direction of the fan is increased without increasing a diameter of the fan, thereby effectively improving the blowing amount of the convection device while suppressing an increase in a cost required for manufacturing the cooking appliance.

### BRIEF DESCRIPTION OF DRAWINGS

FIG. 1 is a perspective view illustrating a cooking appliance according to an embodiment of the present disclosure;

FIG. 2 is a side cross-sectional view showing an internal structure of the cooking appliance shown in FIG. 1.

FIG. 3 is an enlarged view illustrating a portion of the cooking appliance illustrated in FIG. 2.

FIG. 4 is a front perspective view illustrating a fan illustrated in FIG. 3 in a separated state from the cooking appliance.

FIG. 5 is a rear perspective view illustrating the fan shown in FIG. 3 in a separated state from the cooking appliance.

FIG. 6 is a side view illustrating the fan illustrated in FIG. 3 in a separated state from the cooking appliance.

FIG. 7 is a side cross-sectional view illustrating a coupling structure between a first blade portion and a third blade portion illustrated in FIG. 6.

FIGS. 8 and 9 are diagrams schematically showing a form of airflow induced from a general fan.

FIGS. 10 and 11 are diagrams schematically illustrating a form of airflow induced from a fan disposed in a cooking appliance according to an embodiment of the present disclosure.

### DETAILED DESCRIPTIONS

The above-described purposes, features and advantages will be described in detail with reference to the accompanying drawings, and accordingly, a person having ordinary skill in the art to which the present disclosure belongs will be able to easily implement the technical idea of the present disclosure. In describing the present disclosure, a detailed description of known technologies related to the present disclosure will be omitted when it is determined that the gist of the present disclosure may be unnecessarily unclear. Hereinafter, preferred embodiments according to the present disclosure will be described in detail with reference to the accompanying drawings. In the drawings, the same reference numerals are used to refer to the same or similar components.

Although the first, second, and the like are used to describe various components, these components are not limited by these terms. These terms are only used to distinguish one component from another component, and it is obvious that the first component may be the second component unless there is a particular opposite description.

The present disclosure is not limited to the embodiments disclosed below. However, various changes may be applied thereto and the present disclosure may be implemented in various forms different from each other. However, the present embodiment is provided so that the present disclosure is complete and the scope of the present disclosure is fully known to those of ordinary skill in the art. Therefore, the present disclosure is not limited to the embodiments disclosed below, but it should be understood that the present disclosure includes all changes, equivalents, and substitutes included in the technical spirit and scope of the present disclosure, as well as includes replacing the configuration of one embodiment with the configuration of another embodiment and adding the configuration of another embodiment to the configuration of one embodiment.

The accompanying drawings are only set forth for the skilled person to the art to easily understand the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed in an exaggerated or small size in consideration of convenience of understanding or the like. However, the scope of protection of the present disclosure should not be limited thereto.

The terms used herein are used only to describe specific embodiments or implementations, and are not intended to limit the present disclosure. Further, the singular expression of a component includes the plural expression thereof unless the context clearly indicates otherwise. In the present disclosure, the terms “include,” “composed of”, etc. are intended to designate that the features, numbers, steps, operations, components, parts, or combinations thereof described in the present disclosure are present. That is, it should be understood that the terms such as “include” and “composed of” in the present disclosure do not exclude the possibility of the presence or addition of one or more other features, numbers, steps, operations, components, parts, or combinations thereof.

The terms including ordinals, such as first and second, may be used to describe various components, but the components are not limited by the terms. The terms are used only for the purpose of distinguishing one component from another component.

When it is mentioned that one component is “connected” or “coupled” to another component, it should be understood that one component may be directly connected or coupled to another component, or there may be still another component disposed therebetween. On the other hand, when it is stated that one component is “directly connected” or “directly coupled” to another component, it should be understood that still another component is absent therebetween.

When it is mentioned that a component is “on top of” or “under” another component, it should be understood that still another component may be present or absent therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In a state in which the cooking appliance is placed on the floor, a side at which the door is installed around a center of the cooking appliance is defined as a front side. Therefore, when the door is opened, the cooking target enters the cavity of the cooking appliance in a rear direction. For convenience, a front-rear direction may be referred to as a first direction. In this regard, the front side may be referred to as one side in the first direction, and the rear side may be referred to as the other side in the first direction.

In addition, the direction of gravity may be defined as a downward direction and the direction opposite to the direction of gravity may be defined as an upward direction.

In addition, a horizontal direction orthogonal to the front-rear direction of the cooking appliance, that is, a width direction of the cooking appliance in a front view of the door of the cooking appliance may be referred to as a left-right direction. For convenience, the left-right direction may be referred to as a second direction. Then, the right side may be referred to as one side in the second direction, and the left side may be referred to as the other side in the second direction.

In addition, the width direction of the cooking appliance may be referred to as a lateral direction. Then, the right side may be referred to as one side in the lateral direction, and the left side may be referred to as the other side in the lateral direction.

In addition, the above-described vertical direction may be referred to as a third direction. Then, the upper side may be referred to as one side in the third direction, and the lower side may be referred to as the other side in the third direction.

The front-rear direction and the left-right direction, that is, the first direction and the second direction may be first and second horizontal directions.

Throughout the present disclosure, “A and/or B” means A, B, or A and B, unless otherwise specified, and “C to D” means C inclusive to D inclusive unless otherwise specified.

### Overall Structure of Cooking Appliance

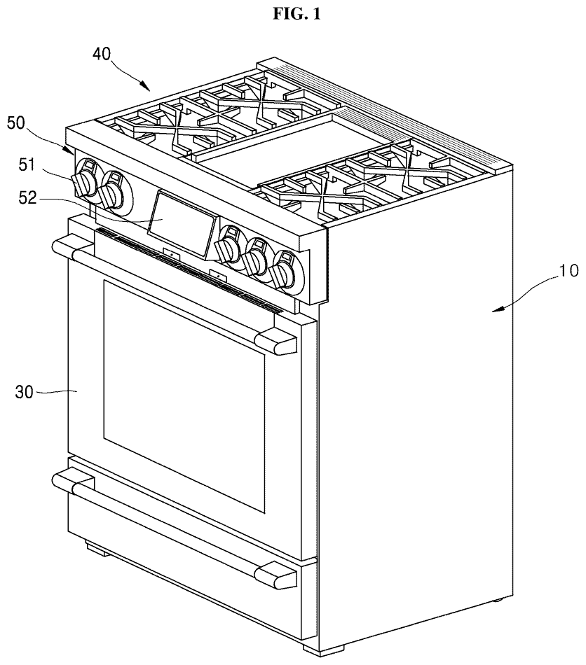

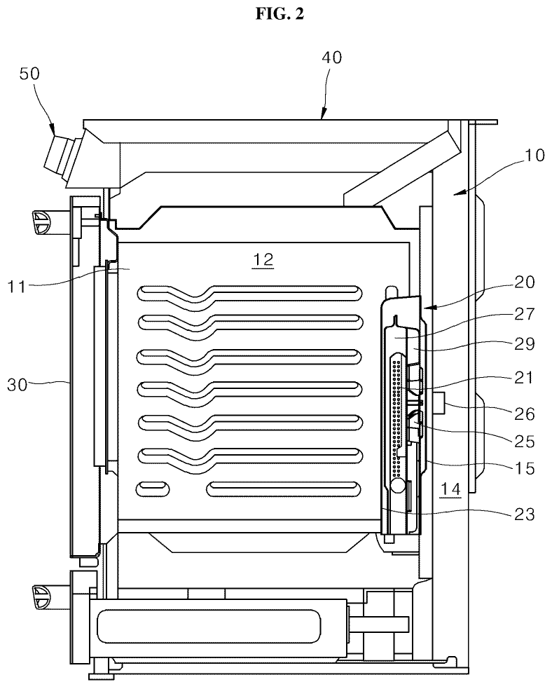

FIG. 1 is a perspective view illustrating a cooking appliance according to an embodiment of the present disclosure, and FIG. 2 is a side cross-sectional view illustrating an internal structure of the cooking appliance illustrated in FIG. 1.

Referring to FIGS. 1 and 2, a main body 10 may define an outer appearance of the cooking appliance. The main body 10 may be formed in a form including a substantially rectangular parallelepiped shape, and may be made of a material having a predetermined strength to protect a plurality of components installed in an inner space thereof.

The main body 10 may include a cavity 11 constituting a skeleton of the main body 10. The cavity 11 may be formed in a hexahedral shape with an open front surface, and a cooking chamber 12 may be defined inside the cavity 11.

The cavity 11 may be formed in a hexahedral shape with an open front surface, and the cooking chamber 12 may be defined inside the cavity 11. That is, the cooking chamber 12 may be formed as a space having a substantially hexahedral shape and defined inside the cavity 11, and may be opened in a frontward direction.

In a state in which the cooking chamber 12 is sealed, food cooking may be performed while the inside of the cooking chamber 12 is heated. That is, in the cooking appliance of the present embodiment embodied as the closed type cooking appliance, the cooking chamber 12 is a space in which food is substantially cooked.

A heater for heating the cooking chamber 12 may be disposed in the cooking appliance. Such a heater may be embodied as a heating device using gas fuel. In another example, the heater may be embodied as a heater using electricity. As such, a structure of the heater may be changed according to a type of a heat source used.

In this embodiment, an example is illustrated in which the heater is embodied as a heating device using gas fuel. Accordingly, a broil burner may be disposed at a top side of the cooking chamber 12, and a convection device 20 may be disposed at a rear side of the cooking chamber 12.

The broil burner may heat the inner space of the cooking chamber 12 while being disposed at the top side thereof. In addition, the convection device 20 suctions the air in the inner space of the cooking chamber 12 and heats the suctioned air, and then discharges the heated air to the inner space of the cooking chamber 12, so that the inner space of the cooking chamber 12 may be uniformly heated.

A door 30 for selectively opening and closing the cooking chamber 12 may be pivotably disposed at the cooking appliance. In an example, the door 30 may be disposed in a form of opening and closing the cooking chamber 12 in a pull-down manner in which an upper end thereof pivots upwardly or downwardly around a lower end thereof.

A cooktop 40 provided to cook food by heating the food or a container containing the food may be disposed at a top side of the main body 10. The cooktop 40 may include an upper plate that closes an upper end of the main body 10 while constituting an outer appearance of an upper surface of the main body 10.

At least one heater for heating food to be cooked or a container containing the food may be disposed in a central area of the cooktop 40. For example, the heater may be embodied as a heating device using gas fuel.

In another example, the heater may be embodied as an induction heater using electricity. The structure of the heater may be changed according to the type of the heat source used as described above.

A control panel 50 may be provided on an upper portion of a front surface of the cooking appliance, that is, an upper portion of a front surface of the cavity 11. The control panel 50 may constitute a portion of an front outer appearance of the cooking appliance. The control panel 50 may include a knob 51 for adjusting an operation of the cooking appliance, a display 52 for displaying an operation state of the cooking appliance, etc.

### Structure of Convection Device

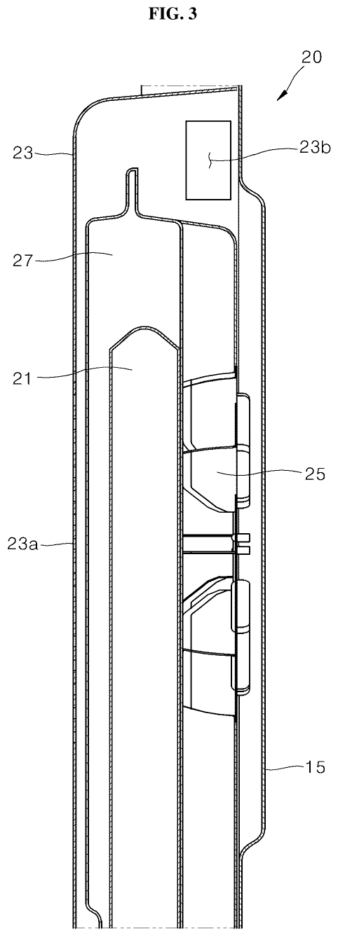

FIG. 3 is an enlarged view illustrating a portion of the cooking appliance illustrated in FIG. 2.

Referring to FIGS. 2 to 3, the convection device 20 may include a burner 21. The burner 21 may be installed inside the main body 10 and may be disposed at the rear side of the cooking chamber 12.

In the present embodiment, an example is illustrated in which the burner 21 is disposed inside the cooking chamber 12 and is positioned closer to the rear side of the cooking chamber 12. The burner 21 may generate a flame by burning a mixed gas in which gas and air are mixed with each other.

In another example, the convection device 20 may include a heater instead of the burner. In this case, the heater may heat the inside of the cooking chamber 12 by generating heat using electricity.

The convection device 20 may include a fan cover 23. The fan cover 23 may be disposed at the rear side of the main body 10, more specifically, at the rear side of the cavity 11. The fan cover 23 may be disposed inside the cooking chamber 12 and may be installed on a rear surface of the cavity 11.

In one example, the fan cover 23 may be formed in a flat polyhedral shape, and a rear surface of the fan cover 23 facing the rear surface of the cavity 11 may be opened. An accommodation space distinguished from the cooking chamber 12 may be defined inside the fan cover 23 constructed as described above. The fan cover 23 may have an air intake hole 23a and an air discharge hole 23b defined therein.

In an example, the air intake hole 23a may be disposed in the front surface of the fan cover 23 facing the front side of the main body 10, that is, facing the door 32. The air intake hole 23a may be formed to extend through the front surface of the fan cover 23 in the front-rear direction.

The air discharge hole 23b may be defined in each of a side surface of the fan cover 23 facing the side surface of the cooking chamber 12 and a bottom surface of the fan cover 23 facing the bottom surface of the cooking chamber 12. The air discharge hole 23b may be formed to extend through the side surface or the bottom surface of the fan cover 23 in a lateral direction or a vertical direction.

The convection device 20 may include a fan 25. The fan 25 may be disposed in the accommodation space defined inside the fan cover 23. The fan 25 may be rotated under an operation of the fan motor 26 connected to the fan 25 to generate airflow.

Air circulation flow may be generated inside the cooking chamber 12 using the fan 25 operated in this way. The air circulation flow generated under the operation of the fan 25 may be generated in a form in which the air in the cooking chamber 12 is suctioned into the accommodation space defined inside the fan cover 23 through the air intake hole 23a and then the air heated in the accommodation space defined inside the fan cover 23 is discharged to the cooking chamber 12 through the air discharge hole 23b.

A detailed structure and the operation of the fan 25 will be described later.

The convection device 20 may further include a burner cover 27. The burner cover 27 may be disposed in the accommodation space defined inside the fan cover 23, and may be formed in a form in which a pair of cover plates separated from each other in the front-rear direction are coupled to each other. The burner cover 27 has a space defined therein in which the burner 21 is accommodated and which surrounds the flame generated from the burner 21.

The burner cover 27 constructed as described above may serve to confine an area in which the flame generated in the burner 21 is diffused to stabilize the flame generated in the burner 21, and to prevent the flame from directly contacting the fan cover 23 and the wall surface of the cavity 11.

In addition, the convection device 20 may further include a reflecting plate 29. The reflecting plate 29 may be disposed in the accommodation space defined inside the fan cover 23, and may be disposed between the rear surface of the cavity 11 and the burner cover 27.

The reflecting plate 29 may prevent the heat generated from the burner 21 from being transferred to the wall surface of the cavity 11 to a certain extent, thereby protecting a coating layer such as an enamel formed on the surface of the cavity 11 from damage caused by the heat.

### Structure of Fan

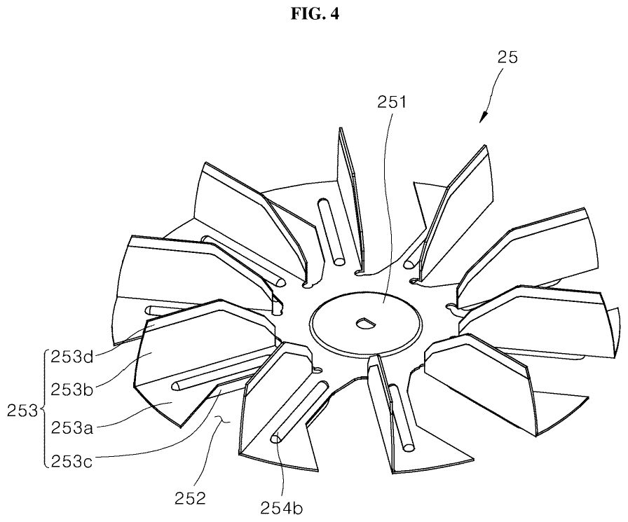

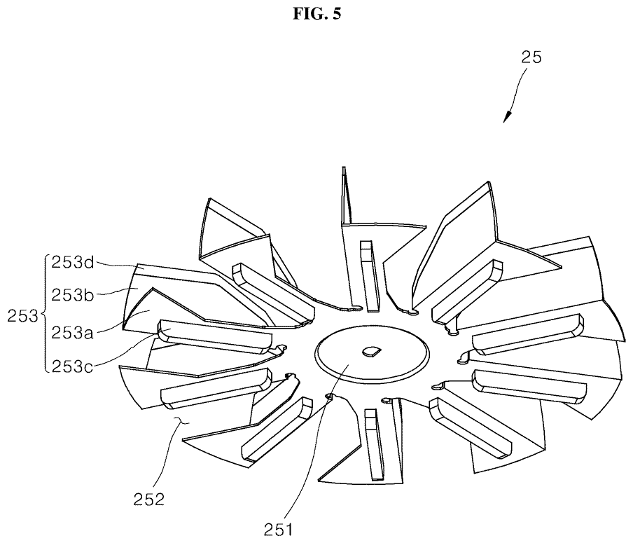

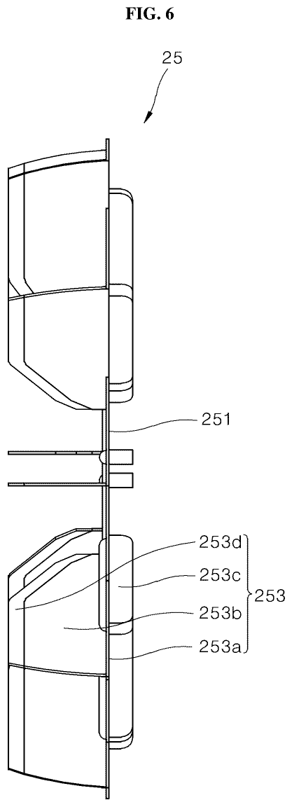

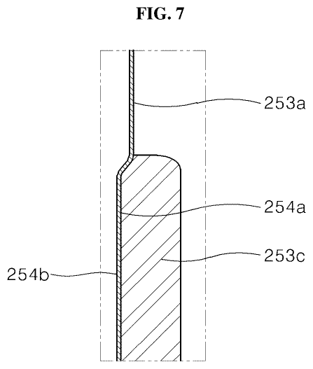

FIG. 4 is a front perspective view illustrating the fan shown in FIG. 3 in a separated state from the cooking appliance, and FIG. 5 is a rear perspective view illustrating the fan shown in FIG. 3 in a separated state from the cooking appliance. FIG. 6 is a side view illustrating the fan shown in FIG. 3 in a separated state from the cooking appliance, and FIG. 7 is a side cross-sectional view illustrating a coupling structure between the first blade portion and the third blade portion shown in FIG. 6.

Referring to FIGS. 2 to 6, the fan 25 may include a rotatable plate 251. The rotatable plate 251 may be constructed to be rotatable about a first direction axis. In the present embodiment, an example in which the first direction is the front-rear direction is set forth. Accordingly, one side in the first direction may be defined as a front side, and the other side in the first direction may be defined as a rear side.

The rotatable plate 251 may be formed in a disk shape including a plane extending in the vertical direction. In one example, the rotatable plate 251 may be formed in a disk shape orthogonal to the first direction axis. The rotatable plate 251 may be connected to the fan motor 26 and rotated under the operation of the fan motor 26.

The fan 25 may include a blade 253. The blade 253 may be disposed radially and outwardly of the rotatable plate 251. A plurality of blades 253 may be disposed in the fan 25. The plurality of blades 253 may be arranged along a rotation direction (hereinafter, referred to as a “rotation direction”) of the rotating plate 251.

In one example, each of the plurality of blades 253 may extend radially around the rotatable plate 251. Each of the blade 253 may be formed in a form protruding from the rotatable plate 251 in a centrifugal direction.

Each of the blades 253 may include a first blade portion 253a. The first blade portion 253a may be formed to extend in the centrifugal direction from the rotatable plate 251. The blade 253 may be connected to the rotating plate 251 via the first blade portion 253a and may rotate together with the rotation of the rotating plate 251. The first blade portion 253a may be formed so as to be coplanar with the rotatable plate 251.

Each of the blades 253 may include a second blade portion 253b which may be formed to extend from the first blade portion 253a. The second blade portion 253b may be formed to protrude from the first blade portion 253a toward one side in the first direction, that is, toward the front side. In addition, each of the blades 253 may include a third blade portion 253c which may be formed in a shape protruding from the first blade portion 253a toward the other side in the first direction, that is, toward the rear side.

That is, in the first direction, the first blade portion 253a may be disposed between the second blade portion 253b and the third blade portion 253c.

A through-hole 252 may be defined in the fan 25. The through-hole 252 may constitute a passage through which the air flows in the first direction in the fan 25. The through-hole 252 may be disposed between two adjacent blades 253. That is, the blades 253 and the through-holes 252 may be alternately arranged with each other in the rotation direction of the rotatable plate.

According to the present embodiment, the fan 25 may be formed into one disk. Accordingly, a central portion of the disk may constitute the rotatable plate 251, and the plurality of blades 253 may be disposed radially outwardly of the disk.

Cutouts may be formed in an outer area in a diameter or radial direction of the disk. The cutout may be formed in a shape in which a portion of the disk is cut away, and a plurality of cutouts may be defined in the disk and be arranged and be spaced apart from each other by a predetermined spacing in the rotation direction.

The cutouts may be arranged to be spaced apart from each other by the spacing corresponding to a length in the rotation direction of each blade 253. A portion of the first blade portion 253a of each blade 253 may be cut away into the cutout, and accordingly, the plurality of blades 253 may be spaced from each other via the cutout.

In one example, the second blade portion 253b may be formed by cutting a portion of the first blade portion 253a and then bending the cut portion toward one side in the first direction that is, toward the front side. Thus, the cutout of the first blade portion 253a may constitute the through-hole 252.

That is, a portion of the first blade portion 253a may be bent in the frontward direction to form the second blade portion 253b. An area occupied with the second blade portion 253b before the bending may act as the through-hole 252.

The through-hole 252 may be coplanar with the first blade portion 253a. That is, in the first direction, the through-hole 252 may be disposed between the second blade portion 253b and the third blade portion 253c.

The blade 252 has one end (hereinafter, referred to as a “leading edge”) of the blade 253 in the rotation direction and the other end (hereinafter, referred to as a “trailing edge”) of the blade 253 in the rotation direction. The second blade portion 253b may be disposed at the trailing edge of the blade 253.

According to the present embodiment, the second blade portion 253b may be formed by bending the other area in the rotation direction of the first blade portion 253a in the first direction, and accordingly, the second blade portion 253b may be disposed at the trailing edge of the first blade portion 253a.

The third blade portion 253c may extend from the first blade portion 253a toward the other side in the first direction, that is, toward the rear side. The third blade portion 253c may be disposed between the leading edge and the trailing edge of the blade 253 in the rotation direction. That is, the third blade portion 253c may not be disposed at an end in the rotation direction of the first blade portion 253a, but may be disposed approximately at a central area in the rotation direction of the first blade portion 253a.

Accordingly, the second blade portion 253b and the third blade portion 253c may not be aligned with each other in a straight line along the front-rear direction but may be offset relative to each other. That is, the second blade portions 253b and the third blade portions 253c may be alternately arranged with each other in the rotation direction.

The third blade portion 253c may be coupled to a plane defined by the first blade portion 253a. That is, the third blade portion 253c may be coupled to the rear surface of the first blade portion 253a facing the third blade portion 253c.

Referring to FIGS. 4 to 7, a coupling groove 254a may be formed in the rear surface of the first blade portion 253a facing the third blade portion 253a. The coupling groove 254a may be formed to be concavely recessed toward one side in the first direction, that is, in the frontward direction from the rear surface of the first blade portion 253a.

At least a portion of the third blade portion 253c may be inserted into the coupling groove 254a. In this inserted state, the first blade portion 253a and the third blade portion 253c may be coupled to each other.

In one example, a coupling protrusion (not shown) may be formed on a front end of the third blade portion 253c, and the coupling protrusion may protrude in the frontward direction and may be inserted into the coupling groove 254a. The coupling between the first blade portion 253a and the third blade portion 253c may be achieved via a fitting coupling of the coupling protrusion into the groove of the first blade portion 253a.

The fitting coupling of the coupling protrusion into the coupling groove 254a of the first blade portion 253a may serve to guide a coupling position of the first blade portion 253a and the third blade portion 253c and also serve to strengthen a coupling force between the first blade portion 253a and the third blade portion 253c.

In addition, a protrusion 254b may be disposed on a front surface of the first blade portion 253a. The protrusion 254b may be formed to protrude from the front surface of the first blade portion 253a toward one side in the first direction, that is, in the frontward direction.

According to the present embodiment, the protrusion 254b may be formed by pressing process for forming the coupling groove 254a. That is, the coupling groove 254a and the protrusion 254b may be formed at the same time in and on the first blade portion 253a in a pressing process of pressing the disk provided to manufacture the fan 25 toward one side in the first direction.

The protrusion 254b may be involved in forming the coupling groove 254a in the first blade portion 253a, and may contribute to strengthening the rigidity of the first blade portion 253a while suppressing occurrence of deformation of the first blade portion 253a.

That is, in the process of forming the coupling groove 254a, the protrusion 254b formed together with the formation of the coupling groove 254a on the first blade portion 253a may provide all of a function of strengthening the rigidity of the blade 253, a function of suppressing the occurrence of the deformation of the blade 253, and a function of strengthening the coupling force between the first blade portion 253a and the third blade portion 253c at the same time.

As described above, the fan 25 of the present embodiment may be disposed in the accommodation space defined inside the fan cover 23, as shown in FIGS. 3 to 6. According to the present embodiment, the front surface of the fan cover 23 may be disposed at one side of the fan 25 in the first direction. In addition, the side surface of the fan cover 23 may be disposed radially outwardly of the fan 25.

The blade 253 may include an extension portion 253d. In one example, the extension portion 253d may protrude from the second blade portion 253b toward one side in the first direction, that is, in the frontward direction. The extension portion 253d may be disposed between the air intake hole 23a and the second blade portion 253b.

In another example, the extension portion 253d may protrude from the second blade portion 253b in a centripetal direction. The extension portion 253d may be disposed between a rotation center of the fan 25 and the second blade portion 253b.

In still another example, the extension portion 253d may protrude from the second blade portion 253b toward one side in the first direction and in the centripetal direction. The extension portion 253d may be disposed between the air intake hole 23a and the second blade portion 253b, and between the rotation center of the fan 25 and the second blade portion 253b. In the present embodiment, an example in which the extension portion 253d protrudes from the second blade portion 253b toward one side in the first direction and in the centripetal direction is set forth.

The extension portion 253d formed as described above may serve to extend the length in the front-rear direction and the length in the radial direction of the second blade portion 253b. That is, an area size of a portion of the blade 253 protruding in the frontward direction may be increased due to the extension portion 253d.

### Operation and Effect of Fan

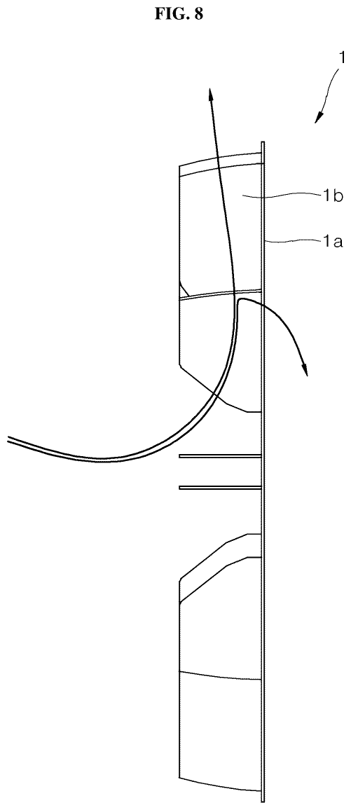

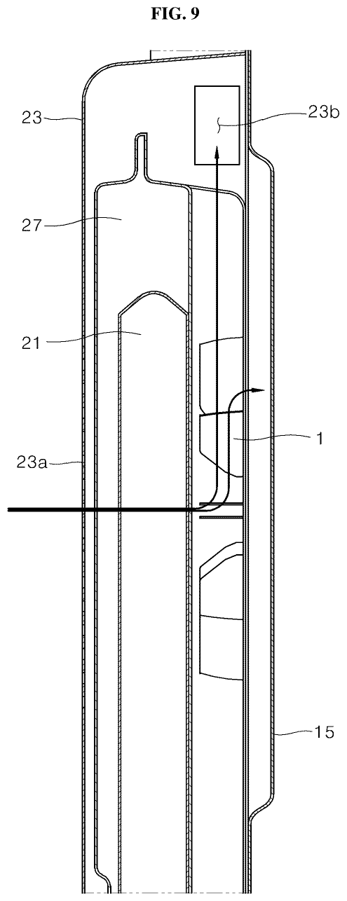

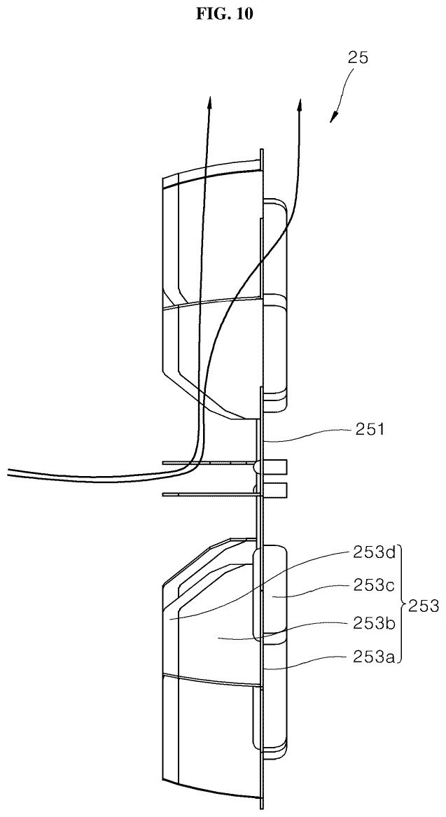

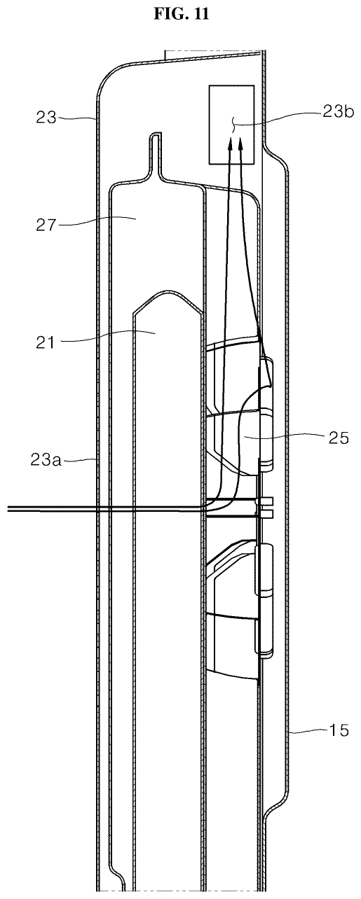

FIGS. 8 and 9 are diagrams schematically illustrating a form of airflow induced in a general fan, and FIGS. 10 and 11 are diagrams schematically illustrating a form of airflow induced in a fan disposed in a cooking appliance according to an embodiment of the present disclosure.

Referring to FIG. 8, a blade of a general fan 1 (hereinafter, referred to as a “conventional fan”) includes only a first blade portion 1a and a second blade portion 1b. In this regard, an example in which the first blade portion la and the second blade portion 1b of the conventional fan 1 are similar to the first blade portion 1a and the second blade portion 1b of the blade 253 according to an embodiment of the present disclosure, respectively is set forth.

When the conventional fan 1 rotates, as shown in FIGS. 8 and 9, air circulation flow may be generated inside the cooking chamber. Accordingly, the air of the cooking chamber 12 may be suctioned into the accommodation space defined inside the fan cover 23 through the air intake hole 23a. That is, an air flow in which the air in the cooking chamber 12 flows backward toward the fan 25 may be generated.

The flow of at least a portion of the air flowing backwards toward the fan 1 is blocked with the first blade portion 253a. The flow of air blocked with the first blade portion 253a may be guided in the centrifugal direction by the second blade portion 253b.

That is, flow of at least a portion of the air suctioned into the accommodation space defined inside the fan cover 23 from the cooking chamber 12 may be guided in a direction toward the air discharge hole 23b defined in the side and bottom surfaces of the fan cover 23. The flow of air guided in the direction toward the air discharge hole 23b may be discharged back to the cooking chamber 12 through the air discharge hole 23b.

In addition, flow of a portion of the air suctioned into the accommodation space defined inside the fan cover 23 from the cooking chamber 12 may flow through the through-hole formed between the first blade portion 253a and the first blade portion 253a. As described above, the flow of air having flowed through the fan 1 does not directly join with the flow of air discharged to the cooking chamber 12 through the air discharge hole 23b, but stays inside the fan cover 23 to some extent.

That is, the flow of air that has flowed through the fan 1 and has flowed to the rear side of the fan 1 does not significantly affect the amount of air discharged through the air discharge hole 23b by the fan 1, that is, the increase in the blowing amount of the fan 1.

In comparison with the conventional fan, referring to FIGS. 2, 10, and 11, in the blade 253 of the fan 25 according to an embodiment of the present disclosure, the third blade portion 253c may be further included in addition to the first blade portion 253a and the second blade portion 253b.

When the fan 25 according to the present embodiment rotates, the air of the cooking chamber 12 may be suctioned into the accommodation space defined inside the fan cover 23 through the air intake hole 23a. At least a portion of the air suctioned into the accommodation space defined inside the fan cover 23 may be discharged back to the cooking chamber 12 through the air discharge hole 23a.

In addition, flow of a portion of the air suctioned into the accommodation space defined inside the fan cover 23 from the cooking chamber 12 may flow through the through-hole 252 of the fan 25. As described above, the flow of air having flowed through the fan 25 may be guided in the centrifugal direction by the third blade portion 253c.

That is, the flow of air having flowed through the fan 25 and having flowed to the rear side of the fan 25 may be guided in a direction toward the air discharge hole 23b by the third blade portion 253c. The flow of air guided in the direction toward the air discharge hole 23b by the third blade portion 253c may join the flow of the air guided by the second blade portion 253b and then be discharged back to the cooking chamber 12 through the air discharge hole 23b.

As described above, in the fan 25 of the present embodiment, the flow of air guided by the third blade portion 253c may be added to the flow of air guided by the second blade portion 253b. That is, the flow of air that has flowed through the fan 25 and has flowed to the rear side of the fan 25 may contribute to an increase in the amount of the air discharged through the air discharge hole 23b by the fan 25, that is, the blowing amount of the fan 25.

In addition, the extension portion 253d may be disposed in the fan 25 of the present embodiment. The extension portion 253d may protrude from the second blade portion 253b toward one side in the first direction and in the centripetal direction, and may be disposed between the air intake hole 23a and the second blade portion 253b and between the rotation center of the fan 25 and the second blade portion 253b.

The extension portion 253d may increase the area size of the second blade portion 253b without increasing the diameter of the fan 25. That is, the extension portion 253d may provide an effect of increasing the blowing amount of the fan 25 without increasing the diameter of the fan 25.

In addition, a fan accommodating portion 15 may be disposed in the cooking appliance of the present embodiment. The fan accommodating portion 15 may be installed at the rear surface of the cavity 11. The fan accommodating portion 15 may have a structure in which a portion of the rear surface of the cavity 11 is concavely recessed rearwardly.

In one example, the fan accommodating portion 15 may be integrally formed with the rear surface of the cavity 11. In another example, the fan accommodating portion 15 may be provided separately from the cavity 11. In this case, a portion of the rear surface of the cavity 11 may be cut away, and the fan accommodating portion 15 may cover the cut away portion and may be coupled to the cavity 11.

The fan accommodating portion 15 may be disposed at a rear side of the fan 25 and may accommodate therein at least a portion of the fan 25. In one example, the third blade portion 253c may be accommodated in the fan accommodating portion 15. In addition, a portion of each of the first blade portion 253a and the second blade portion 253b may also be accommodated in the fan accommodating portion 15.

Preferably, the first blade portion 253a and the third blade portion 253c may be accommodated in the fan accommodation portion 15, and a portion of the second blade portion 253b may also be accommodated in the fan accommodation portion 15. In this regard, a portion of the second blade portion 253b corresponding to the protrusion length in the front-rear direction of the extension portion 253d may be accommodated in the fan accommodation portion 15.

According to the present embodiment, as the third blade portion 253c and the extension portion 253d are disposed in the fan 25, the diameter of the fan 25 does not increase, while the size in the front-rear direction of the fan 25 may increase.

If the diameter of the fan 25 increases, the fan cover should be designed again to be adapted to the increase. However, the design of the fan cover takes a long time and a lot of a cost. Thus, increasing the diameter of the fan 25 to increase the blowing amount of the fan 25 is not a desirable scheme.

On the other hand, as in the fan 25 illustrated in the present embodiment, the diameter of the fan 25 is not increased and only the front-rear directional size of the fan 25 is increased. Thus, the existing fan cover 23 may be applied to the cooking appliance in a non-modified design thereof.

In the present embodiment, the front-rear directional size of the fan 25 is a little increased. However, an effect due to this increase may be removed using the fan accommodating portion 15. That is, the portion of the fan 25 protruding in the front-rear direction may be accommodated in the fan accommodating portion 15 concavely recessed rearwards from the rear surface of the cavity 11, such that the fan 25 may be accommodated in the fan cover 23 without any problem even though the front-rear directional size of the fan cover 23 does not increase.

A rear space 14 may be defined in rear of the cavity 11. The rear space 14 is a space defined between a cabinet (not shown) constituting an outer appearance of the cooking appliance and the rear surface of the cavity 11, and the fan motor 26, etc. may be disposed in the rear space 14.

The fan accommodating portion 15 protrudes toward the rear space 14 as a space required to be formed in the above manner anyway, so that a space necessary to accommodate the protrusion of the fan 25 therein may be secured inside the fan accommodating portion 15. Accordingly, the fan 25 according to the present embodiment may be effectively installed without changing the size of the cooking appliance.

As described above, the fan 25 of the present embodiment may be constructed such that the fan 25 having a substantially increased size may be installed in the cooking appliance without a design change of the fan cover 23, thereby effectively improving the blowing amount of the convection device while suppressing an increase in the cost required for manufacturing the cooking appliance.

Although the present disclosure has been described above with reference to the embodiments illustrated in the drawings, this is merely an example, and it will be understood by those of ordinary skill in the art that various modifications and other equivalent embodiments are possible therefrom. Therefore, the true technical protection scope of the present disclosure should be determined by the following claims.

### Reference Numerals

1: Conventional fan
1a: First blade portion
1b: Second blade portion
10: Main body
11: Cavity
12: Cooking chamber
15: Fan accommodation portion
20: Convection device
21: Burner
21a: Burner body
21b: Flame hole
23: Fan Cover
23a: Air intake hole
23b: Air discharge hole
25: Fan
251: Rotatable plate
251a: Coupling groove
251b: Protrusion
252: Through-hole
253: Blade
253a: First Blade portion
253b: Second blade portion
253c: Third blade portion
26: Fan motor
27: Burner cover
29: Reflecting plate
30: Door
40: Cooktop
50: Control panel
51: Knob
52: Display

1. A cooking appliance comprising:
a main body having a cooking chamber defined therein; and
a fan installed in the main body,
wherein the fan includes:
a rotating plate constructed to be rotatable about an axis extending in a first direction; and
a blade disposed radially outwardly of the rotating plate,
wherein the blade includes a plurality of blades arranged along a rotation direction of the rotatable plate,
wherein each of the blades includes:
a first blade portion extending in a centrifugal direction from the rotatable plate;
a second blade portion protruding from the first blade portion toward one side in the first direction; and
a third blade portion protruding from the first blade portion toward the other side in the first direction.

2. The cooking appliance of claim 1, wherein the second blade portions and the third blade portions are alternately arranged with each other along the rotation direction of the rotatable plate.

3. The cooking appliance of claim 1, wherein the fan further includes a through-hole extending through the blade in the first direction,
wherein the through-hole is disposed between the second blade portion and the third blade portion in the first direction.

4. The cooking appliance of claim 3, wherein the second blade portion is formed by cutting a portion of the first blade portion and then bending the cut portion toward one side in the first direction,
wherein a cut-away area of the first blade portion constitutes the through-hole.

5. The cooking appliance of claim 1, wherein a coupling groove is defined in a rear surface of the first blade portion facing the third blade portion and is concavely recessed toward one side in the first direction,
wherein at least a portion of the third blade portion is inserted into the coupling groove such that the third blade portion is coupled to the first blade portion.

6. The cooking appliance of claim 5, wherein a protrusion protrudes from a front surface of the first blade portion toward one side in the first direction,
wherein the coupling groove and the protrusion are formed together with each other in a pressing process for forming the coupling groove.

7. The cooking appliance of claim 1, wherein the cooking appliance further comprises a fan cover disposed inside the cooking chamber and having an accommodation space defined therein accommodating therein the fan,
wherein a front surface of the fan cover is disposed on one side in the first direction of the fan, and a side surface of the fan cover is disposed radially outwardly of the fan,
wherein an air intake hole is defined in the front surface of the fan cover,
wherein an air discharge hole is defined in the side surface of the fan cover.

8. The cooking appliance of claim 7, wherein each blade further includes an extension portion protruding from the second blade portion toward one side in the first direction, wherein the extension portion is disposed between the air intake hole and the second blade portion.

9. The cooking appliance of claim 7, wherein each blade further includes an extension portion protruding from the second blade portion in a centripetal direction, wherein the extension portion is disposed between a rotation center of the fan and the second blade portion.

10. The cooking appliance of claim 7, wherein each blade further includes an extension portion protruding from the second blade portion toward one side in the first direction and in a centripetal direction, wherein the extension portion is disposed between the air intake hole and the second blade portion and between a rotation center of the fan and the second blade portion.
